(19) United States
(12) Patent Application Publication
(10) Pub. No.: US 2023/0317315 A1
(43) Pub. Date: Oct. 5, 2023

(54) TWO-CORE CABLE

(71) Applicant: SUMITOMO ELECTRIC INDUSTRIES, LTD., Osaka (JP)

(72) Inventors: Jun OTSUKA, Tochigi (JP); Yuko YAMAGUCHI, Tochigi (JP); Yuto KOBAYASHI, Tochigi (JP); Tatsunori HAYASHISHITA, Tochigi (JP)

(21) Appl. No.: 18/188,712

(22) Filed: Mar. 23, 2023

(30) Foreign Application Priority Data
Mar. 30, 2022 (JP) 2022-057281

(51) Int. Cl. H01B 7/18; H01B 7/22

(52) U.S. Cl. CPC H01B 7/1875; H01B 7/221

(57) ABSTRACT

A two-core cable includes two coated wires and a metal tape. Each of the two coated wires includes a conductor and an insulating layer that covers an outer surface of the conductor, and the metal tape is configured to collectively cover outer surfaces of the two coated wires. The metal tape has a structure in which a resin layer and a metal layer are stacked, and the resin layer is located towards the two coated wires relative to the metal layer.

### CROSS-REFERENCE TO RELATED APPLICATIONS

This application is based on and claims priority to Japanese Patent application No. 2022-057281, filed on Mar. 30, 2022, the entire contents of which are incorporated herein by reference.

### TECHNICAL FIELD

The present disclosure relates to a two-core cable.

### BACKGROUND

Japanese Laid-Open Patent Publication No. 2005-259660 (Patent Document 1) describes a Twinax cable that includes a pair of conductors arranged in parallel, a pair of sheath layers, a pair of round-pipe-shaped core outer layers, a drain wire provided between the core outer layers, and a shielding member that shields the core outer layers and the drain wire. In the Twinax cable described in Patent Document 1, each of the sheath layers is provided on the outer peripheral surface of a corresponding conductor of the pair of conductors by extrusion molding, is formed of an insulating resin, and includes a round-pipe-shaped sheath layer body covering the outer peripheral surface of the corresponding conductor and a spiral protrusion integrally formed on the outer peripheral surface of the sheath layer body, and each of the round-pipe-shaped core outer layers is provided on the outer peripheral surface of a corresponding sheath layer so as to cover the corresponding sheath layer and is formed of an insulating material.

Two-core cables that are also referred to as Twinax cables are conventionally used for transmission of signals and the like. For example, as described in Patent Document 1, various studies have been made to improve the performance of such cables.

In recent years, there has been a demand for two-core cables that enable high-speed communication, that is, that can transmit high-frequency band signals. In order to obtain two-core cables that can transmit high-frequency band signals, there has been a demand for two-core cables that can reduce the amount of differential-mode to common-mode conversion.

### SUMMARY

According to the present disclosure, a two-core cable includes two coated wires and a metal tape. Each of the two coated wires includes a conductor and an insulating layer that covers an outer surface of the conductor, and the metal tape is configured to collectively cover outer surfaces of the two coated wires. The metal tape has a structure in which a resin layer and a metal layer are stacked, and the resin layer is located towards the two coated wires relative to the metal layer.

### BRIEF DESCRIPTION OF THE DRAWINGS

Other objects and further features of the present invention will be apparent from the following detailed description when read in conjunction with the accompanying drawings, in which:

FIG. 1 is a cross-sectional view of a two-core cable taken along a plane perpendicular to the longitudinal direction of the two-core cable according to an embodiment of the present disclosure;

FIG. 2 is a cross-sectional view of a metal tape taken along a plane parallel to the stacking direction of a resin layer and a metal layer of the metal tape;

FIG. 3 is a cross-sectional view of a two-core cable taken along a plane perpendicular to the longitudinal direction of the two-core cable according to an embodiment of the present disclosure;

FIG. 4 is a drawing illustrating another example configuration of a coated wire; and

FIG. 5 is a graph illustrating the results of measuring Scd21 of a cable manufactured in Experimental Example 4.

### DETAILED DESCRIPTION

According to the present disclosure, a two-core cable capable of reducing the amount of differential-mode to common-mode conversion can be provided.

In the following, embodiments of the present disclosure will be described.

### Description of Embodiments of Present Disclosure

First, the embodiments of the present disclosure will be listed and described. In the following description, the same or corresponding components are denoted by the same reference numerals and the description thereof will not be repeated.

(1) According to an embodiment of the present disclosure, a two-core cable includes two coated wires and a metal tape. Each of the two coated wires includes a conductor and an insulating layer that covers an outer surface of the conductor, and the metal tape is configured to collectively cover outer surfaces of the two coated wires. The metal tape has a structure in which a resin layer and a metal layer are stacked, and the resin layer is located towards the two coated wires relative to the metal layer.

By disposing the metal tape such that the resin layer is located towards the two coated wires, the two-core cable capable of reducing the amount of differential-mode to common-mode conversion can be obtained.

(2) Portions of the metal tape may overlap each other in a cross section perpendicular to a longitudinal direction of the two-core cable. In the cross section, both end portions of the metal tape may be respectively disposed outward, in a width direction of the two-core cable, relative to contact points each of which is an intersection point of an outer periphery of a corresponding coated wire of the two coated wires and a common external tangent to the two coated wires.

By disposing the end portions of the metal tape as described above, the shape of the two-core cable can be stabilized, and the electrical characteristics of the two-core cable can be also stabilized.

(3) In the cross section, the both end portions of the metal tape may be respectively disposed in regions each of which is located between the contact point and an intersection of a line passing through centers of the two coated wires and the metal tape.

By disposing the end portions of the metal tape in the above-described respective regions, the shape of the two-core cable can be stabilized, and the electrical characteristics of the two-core cable can be also stabilized.

(4) The metal tape may be longitudinally wrapped around the two coated wires.

By wrapping the metal tape longitudinally, the metal tape can be readily disposed as compared to when the metal tape is spirally wrapped.

(5) The resin layer may have a thickness of 5 μm or more to 25 μm or less.

By setting the thickness of the resin layer to 5 μm or more, a resin-containing layer disposed in the surroundings of the conductor of the two-core cable can have a sufficient thickness, and the amount of mode conversion can be particularly reduced. By setting the thickness of the resin layer to 25 μm or less, the metal tape can be readily wrapped around the two coated wires, and the shape of the two-core cable can be stabilized.

(6) A dissipation factor of the resin layer may be higher than a dissipation factor of the insulating layer.

By setting the dissipation factor of the resin layer to be higher than the dissipation factor of the insulating layer, common mode signals can be particularly reduced, and the amount of mode conversion can be reduced.

(7) The insulating layer may include a foam layer that is a foamed layer.

The relative dielectric constant of air is approximately 1 and is lower than the relative dielectric constant of a resin used for the insulating layer. Thus, the relative dielectric constant of the foam layer is lower than the relative dielectric constant of a solid layer that is not a foam layer. Accordingly, when the insulating layer includes the foam layer, the relative dielectric constant of the insulating layer can be reduced, and the thickness of the insulating layer, required for each of the coated wires to have a predetermined characteristic impedance, can also be reduced. As a result, the sizes of the coated wires and the two-core cable can be reduced.

(8) The foam layer may have a foaming ratio of 0% or more to 70% or less.

By setting the foaming ratio of the foam layer to 70% or less, the strength of the foam layer and the strength of the insulating layer including the foam layer can be increased, and thus, the conductor can be protected. In addition, by setting the foaming ratio of the foam layer to 70% or less, the shapes of the coated wires and the two-core cable including the coated wires can be stabilized.

By setting the foaming ratio of the foam layer to 0% or more, the relative dielectric constant of the insulating layer can be reduced, and the sizes of the coated wires and the two-core cable can be reduced.

### Details of Embodiments of Present Disclosure

Specific examples of a two-core cable according to each embodiment (hereinafter referred to as the “present embodiment”) of the present disclosure will be described below with reference to the accompanying drawings. Note that the present invention is not limited to these examples, and is intended to include all changes and modifications within the scope of the appended claims and within the meaning and scope of the equivalents of the appended claims.

### Two-Core Cable

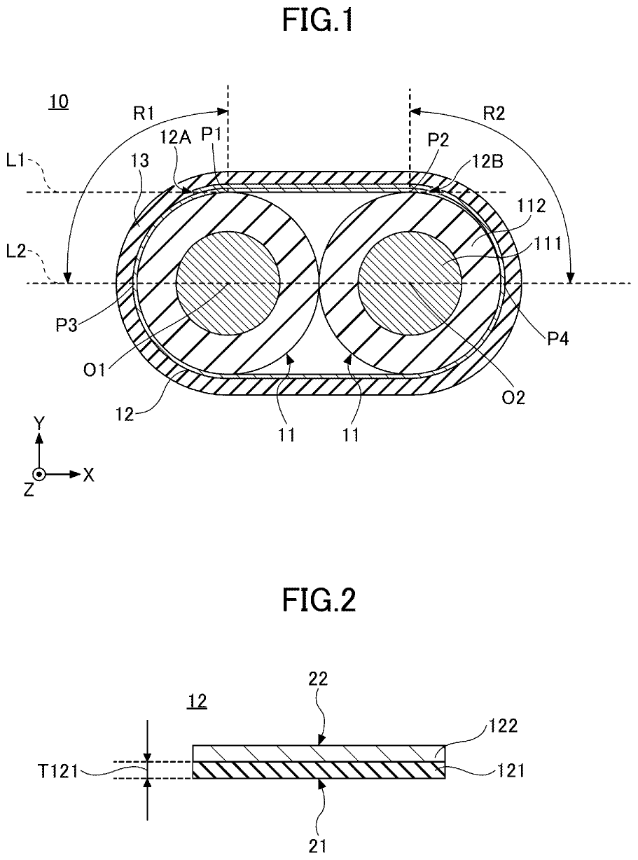

FIG. 1 is a cross-sectional view of a two-core cable 10 taken along a plane perpendicular to the longitudinal direction of the two-core cable 10 according to an embodiment. In FIG. 1, the X-axis direction is the width direction of the two-core cable 10, the Y-axis direction is the thickness direction of the two-core cable 10, and the Z-axis direction perpendicular to the paper surface is the longitudinal direction of the two-core cable 10. The outer surface side of the two-core cable 10 in width direction (X-axis direction) may be referred to as the outer side.

As illustrated in FIG. 1, the two-core cable 10 according to the present embodiment includes two coated wires 11 and a metal tape 12 configured to collectively cover the outer surfaces of the two coated wires 11. Components of the two-core cable according to the present embodiment will be described below.

### (1) Coated Wire

As illustrated in FIG. 1, each of the two coated wires 11 includes a conductor 111 and an insulating layer 112 covering the outer surface of the conductor 111. The two coated wires 11 can be arranged in parallel to each other without being twisted together.

### (1-1) Conductor

The material of the conductor 111 is not particularly limited. As the material of the conductor 111, one or more conductive materials selected from, for example, copper, annealed copper, silver, nickel-plated annealed copper, tin-plated annealed copper, and the like can be used. For example, in order to adjust the elongation or the like of the conductor 111, the conductor 111 may be subjected to an annealing process.

The conductor 111 may be a solid wire or may be a stranded wire. From a viewpoint of particularly increasing the electrical characteristics of the coated wires 11, the conductor 111 is preferably a solid wire.

### (1-2) Insulating Layer

The material of the insulating layer 112 is not particularly limited, and can be selected according to characteristics or the like required for the two-core cable 10.

The insulating layer 112 can contain, for example, a resin. The resin is not particularly limited. Examples of the resin that can be used include one or more resins selected from fluororesins such as polytetrafluoroethylene (PTFE), tetrafluoroethylene-perfluoroalkylvinyl ether copolymer (PFA), tetrafluoroethylene-hexafluoropropylene copolymer (FEP), and ethylene-tetrafluoroethylene copolymer (ETFE); polyester resins such as polyethylene terephthalate (PET); and polyolefin resins such as polyethylene and polypropylene. The resin of the insulating layer 112 may be cross-linked or may not necessarily be cross-linked.

The insulator 112 can also contain an additive, such as a flame retardant, a flame retardant aid, an antioxidant, a lubricant, a colorant, a reflective additives, a concealer, a processing stabilizer, a plasticizer, or the like, in addition to the above-described resin.

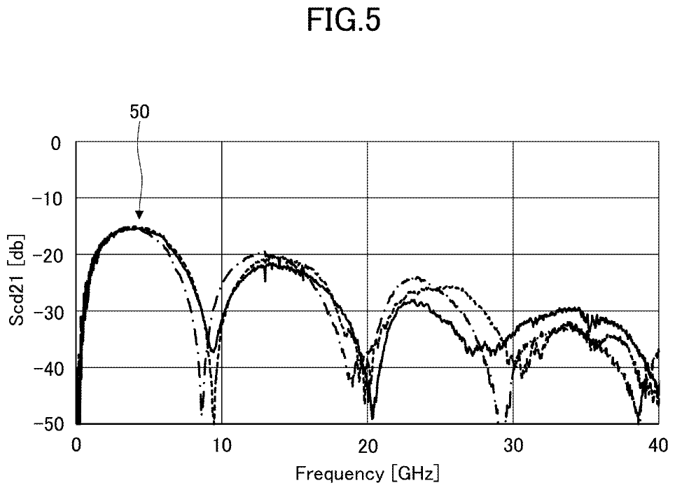

For example, as with the case of a coated wire 100 illustrated in FIG. 4, the insulating layer 112 may have a multilayer structure including a plurality of layers. In the example of in FIG. 4, the insulating layer 112 includes a first insulating layer 1121, a second insulating layer 1122, and a third insulating layer 1123 in order from the conductor 111 side, but the configuration of the insulating layer 112 is not limited thereto. The insulating layer 112 may include two layers or four or more layers. If the insulating layer 112 includes the plurality of layers, configurations such as materials of some or all of the layers may be different from each other.

The insulating layer 112 can also include a foam layer that is a foamed layer. For example, in the coated wire 100 illustrated in FIG. 4, the second insulating layer 1122 may be a foam layer. The term “foam layer” refers to a layer including air bubbles.

The relative dielectric constant of air is approximately 1, and is lower than that of the relative dielectric constant of the resin used for the insulating layer 112. Therefore, the relative dielectric constant of the foam layer is lower than the relative dielectric constant of a solid layer that is not a foam layer. Accordingly, when the insulating layer 112 includes the foam layer, the relative dielectric constant of the insulating layer 112 can be reduced, and the thickness of the insulating layer 112, required for the coated wire 100 to have a predetermined characteristic impedance, can also be reduced. As a result, the sizes of the coated wires 11 and the two-core cable 10 can be reduced.

The degree of foaming of the foam layer is not particularly limited. However, since the insulating layer 112 including the foam layer also functions to protect the conductor 111, it is preferable for the insulating layer 112 to have an appropriate strength. For this reason, the foaming ratio of the foam layer is preferably 70% or less, and more preferably 65% or less.

By setting the foaming ratio of the foam layer to 70% or less, the strength of the foam layer and the strength of the insulating layer 112 including the foam layer can be increased, and thus, the conductor 111 can be protected. In addition, by setting the foaming ratio of the foam layer to 70% or less, the shapes of the coated wires 11 and the two-core cable 10 including the coated wires 11 can be stabilized.

The lower limit value of the foaming ratio of the foam layer is not particularly limited, but is preferably more than 0%, and more preferably 5% or more.

By setting the foaming ratio of the foam layer to be more than 0%, the relative dielectric constant of the insulating layer 112 can be reduced, and thus, the sizes of the coated wires 11 and the two-core cable 10 can be reduced.

If the insulating layer 112 includes the foam layer, it is preferable for the insulating layer 112 to also include a solid layer that is a non-foamed layer. The foaming ratio of the solid layer is 0%. Therefore, when the solid layer is included, the shape of each of the coated wires 11 can be readily maintained, and the conductor 111 can be protected. For example, as illustrated in FIG. 4, the insulating layer 112 can have a three-layer structure, and the first insulating layer 1121 and the third insulating layer 1123 can be solid layers, and the second insulating layer 1122 can be a foam layer.

The foaming ratio can be calculated from the ratio of the specific gravity of a foam layer before foaming to the specific gravity of the foam layer after foaming. Specifically, for example, the foaming ratio can be calculated by dividing the measured value of the specific gravity after foaming by the measured value of the specific gravity before foaming. The specific gravity before foaming can be measured, for example, by cutting out a portion that does not contain foam from the foam layer.

### (2) Metal Tape

The two-core cable 10 according to the present embodiment can include the metal tape 12 configured to collectively cover the two coated wires.

The inventors of the present invention have investigated a two-core cable in which the amount of differential-mode to common-mode conversion is reduced, that is, common mode signals are reduced. As a result, the inventors have found that the above-described amount of mode conversion can be reduced by disposing a metal tape, covering two coated wires and including a resin layer and a metal layer, such that the resin layer is located towards the two coated wires, instead of disposing the metal tape such that the metal layer is located towards the two coated wires as in a conventional manner. The inventors have completed the invention based on this finding.

FIG. 2 illustrates a cross-sectional view of the metal tape 12 taken along a plane in the stacking direction of the resin layer and the metal layer. As illustrated in FIG. 2, the metal tape 12 has a structure in which a resin layer 121 and a metal layer 122 are stacked. That is, the metal tape 12 includes the resin layer 121 and the metal layer 122 that is disposed on one surface of the resin layer 121. In the two-core cable 10 according to the present embodiment, the resin layer 121 of the metal tape 12 can be located towards the two coated wires 11. That is, a first surface 21 of the resin layer 121 of the metal tape 12 illustrated in FIG. 2 can be located towards the coated wires 11 side, and a second surface 22 of the metal layer 122 can be located towards the outer surface of the two-core cable 10.

The two-core cable 10 that reduces the amount of differential-mode to common-mode conversion can be obtained by disposing the resin layer 121 of the metal tape 12 to be located towards the two coated wires 11 as described above.

The distribution of an electromagnetic field formed around the coated wires 11 differs between a differential mode and a common mode.

In differential mode, an electromagnetic field is distributed between conductors 111 and between the metal tape 12 and the conductors 111, and the strength of the electromagnetic field distributed between the conductors 111 becomes high. Conversely, in common mode, an electromagnetic field is hardly distributed between the conductors 111 and is mainly distributed between the metal tape 12 and the conductors 111. For this reason, it is considered that an environment between the metal tape 12 and each of the conductors 111 has a strong influence on the common mode. Therefore, common mode signals can be attenuated and the amount of mode conversion can be reduced by disposing the resin layer 121 of the metal tape 12 to be located towards the two coated wires 11, thereby increase the thickness of a resin-containing layer constituted by the insulating layer 112 and the resin layer 121.

An adhesive layer can also be disposed on the surface of the resin layer 121 of the metal tape 12, that is, on the first surface 21. By disposing the adhesive layer, the metal tape 12 can be bonded to the two coated wires 11, and the shape of the two-core cable 10 can be stabilized.

As illustrated in FIG. 1, the metal tape 12 can be disposed to collectively cover the outer surfaces of the two coated wires 11. In FIG. 1, portions of the metal tape 12 between the two coated wires 11 are linear, but the configuration of the metal tape 12 is not limited thereto, and the portions of the metal tape 12 between the two coated wires 11 may be recessed towards the coated wires 11.

The metal tape 12 is preferably longitudinally wrapped around the two coated wires 11. As compared to when the metal tape 12 is spirally wrapped, the metal tape 12 can be readily disposed when the metal tape 12 is longitudinally wrapped.

In a cross section perpendicular to the longitudinal direction of the two-core cable 10, the metal tape 12 is preferably disposed such that portions of the metal tape 12 overlap each other. In this case, in a cross section perpendicular to the longitudinal direction of the two-core cable 10, the metal tape 12 has an end portion 12A and an end portion 12B located on the inner peripheral side of the metal tape 12 relative to the end portion 12A. As illustrated in FIG. 1, the end portion 12B located on the inner peripheral side of the metal tape 12 is covered by the metal tape 12. That is, as illustrated in FIG. 1, portions of the metal tape 12 can overlap each other to form a two-layer structure between the end portion 12A and the end portion 12B.

In a cross-section as described above, the end portion 12A and the end portion 12B, which are both end portions of the metal tape 12, are preferably disposed outward, in the width direction of the two-core cable 10, relative to a contact point P1 and a contact point P2, respectively. Each of the contact point P1 and the contact point P2 is located between the outer periphery of a corresponding one of the two coated wires 11 and a common external tangent L1 to the two coated wires 11. The end portion 12B is located on the inner periphery side of the metal tape 12 relative to the end portion 12A. As described above, the width direction of the two-core cable 10 is the X-axis direction in FIG. 1, and can be also referred to as the arrangement direction of the two coated wires.

By disposing the end portion 12A and the end portion 12B of the metal tape 12 as described above, the shape of the two-core cable 10 can be stabilized, and the electrical characteristics of the two-core cable 10 can be also stabilized. The end portion 12A and the end portion 12B of the metal tape 12 are preferably disposed at positions along the outer surfaces of the coated wires 11 as illustrated in FIG. 11.

In a cross section perpendicular to the longitudinal direction of the two-core cable 10, the length of a region where the portions of the metal tape 12 overlap each other is not particularly limited, but is preferably half or less of the sum of the length of a region where the portions of the metal tape 12 do not overlap each other and the length of the region where the portions of the metal tape 12 overlap each other.

The end portion 12A of the metal tape 12 is more preferably disposed in a region R1 between a point P3 and the above-described contact point P1. The point P3 is the intersection of a line L2, passing through a center O1 and a center O2 of the two coated wires 11, and the metal tape 12. Further, the end portion 12B of the metal tape 12 is more preferably disposed in a region R2 between a point P4 and the above-described contact point P2. The point P4 is the intersection of the line L2, passing through the center O1 and the center O2 of the two coated wires 11, and the metal tape 12.

That is, in a cross section as described above, the end portion 12A and the end portion 12B, which are both end portions of the metal tape 12, are preferably disposed in the region R1 and the region R2, respectively. The region R1 is located between the point P3, which is the intersection of the line passing through the centers of the two coated wires 11 and the metal tape 12, and the above-described contact point P1, and the region R2 is located between the point P4, which is the intersection of the line passing through the centers of the two coated wires 11 and the metal tape 12, and the above-described contact point P2.

By disposing the end portion 12A and the end portion 12B of the metal tape 12 in the above-described respective regions, the shape of the two-core cable 10 can be stabilized, and the electrical characteristics of the two-core cable 10 can be also stabilized.

Note that the centers O1 and O2 of the coated wires 11 when drawing the above line L2 can be the centers of circumscribed circles of the respective coated wires 11.

The material of the resin layer 121 of the metal tape 12 is not particularly limited as long as the resin layer 121 contains a resin. The resin contained in the resin layer 121 may be the same as or different from that contained in the insulating layer 112 of each of the coated wires 11.

The dissipation factor (tan δ) of the resin layer 121 can be made higher than the dissipation factor of the insulating layer 112 of each of the coated wires 11. By setting the dissipation factor of the resin layer 121 to be higher than the dissipation factor of the insulating layer 112, common mode signals can be particularly reduced, and the amount of mode conversion can be reduced.

Examples of the resin contained in the resin layer 121 include polyethylene terephthalate (PET) and polyethylene naphthalate (PEN).

As the metal layer 122, a metal foil can be used, for example. The material of the metal foil is not particularly limited, but copper or aluminum may be used.

A thickness T121 of the resin layer 121 is not particularly limited, but is preferably 5 μm or more and 25 μm or less, and more preferably 9 μm or more and 15 μm or less. By setting the thickness T121 of the resin layer 121 to 5 μm or more, the resin-containing layer disposed in the surroundings of the conductor 111 of the two-core cable 10 can have a sufficient thickness, and the amount of mode conversion can be reduced. By setting the thickness T121 of the resin layer 121 to 25 μm or less, the metal tape 12 can be readily wrapped around the two coated wires 11, and the shape of the two-core cable 10 can be stabilized.

### (3) Wrapping Tape

In the two-core cable 10 according to the embodiment, a wrapping tape 13 can be disposed to cover the outer surface of the metal tape 12. The wrapping tape 13 can be formed by wrapping a tape body spirally around the outer periphery of the metal tape 12 along the longitudinal direction of the two-core cable 10.

When the two-core cable 10 includes the wrapping tape 13, the shape of the metal tape 12 and the shape and the electrical characteristics of the two-core cable 10 can be stabilized. Further, the positions of the end portion 12A and the end portion 12B of the metal tape 12 can be adjusted by adjusting the tension applied to the wrapping tape 13 when the wrapping tape 13 is wrapped around the outer periphery of the metal tape 12.

The material of the wrapping tape 13 is not particularly limited. As the material of the wrapping tape 13, one or more insulating materials selected from paper, a non-woven fabric, and a resin such as polyester can be used.

The wrapping tape 13 may be formed of a single layer or two or more layers.

An adhesive layer may be disposed on the surface on the metal tape 12 side of the wrapping tape 13. By disposing the adhesive layer, the wrapping tape 13 can be bonded to the metal tape 12, and the shape of the two-core cable 10 can be stabilized.

### (4) Drain Wire

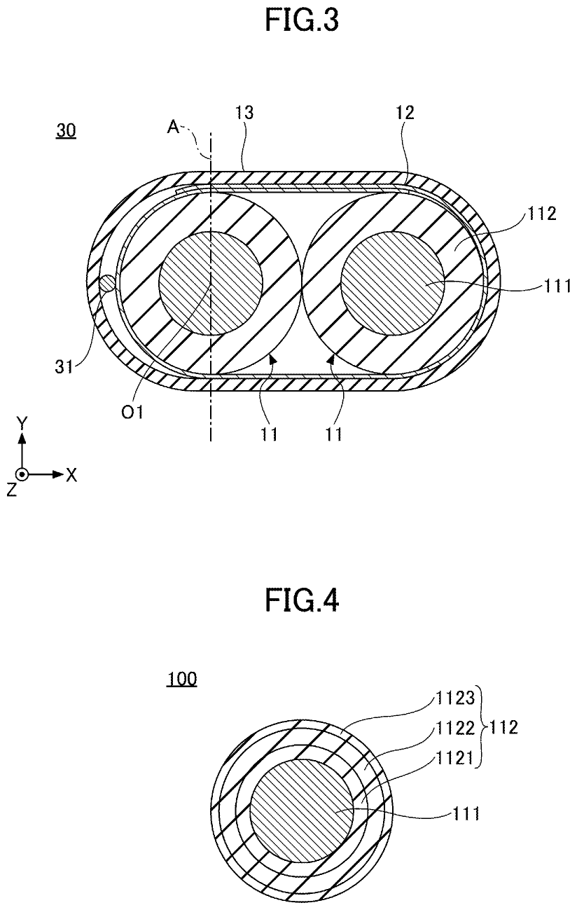

As illustrated in FIG. 3, a two-core cable according to an embodiment can include a drain wire 31. The two-core cable 30 illustrated in FIG. 3 can have the same configuration as the two-core cable 10 illustrated in FIG. 1 except that the two-core cable 30 includes the drain wire 31. When the two-core cable 30 includes the drain wire 31, the metal layer 122 of the metal tape 12 can be readily connected to a terminal or the like via the drain wire 31.

Accordingly, the drain wire 31 can be disposed in contact with the metal layer 122. For example, as illustrated in FIG. 3, the drain wire 31 can be disposed between the metal tape 12 and the wrapping tape 13 and can be fixed by the wrapping tape 13.

The arrangement of the drain wire 31 is not particularly limited as long as the drain wire 31 is disposed in contact with the metal layer 122. However, since the allowable range of the thickness, that is, the length in the Y-axis direction, of the two-core cable 30 in FIG. 3 is often narrow, the two-core cable 30 is preferably disposed on the side surface of the two-core cable 30. For example, the two-core cable 30 is preferably disposed outward, in the width direction of the coated wires 11, that is, in the X-axis direction, relative to a line A passing through the center O1 of a corresponding one of the coated wires 11 illustrated in FIG. 3.

The configuration of the drain wire 31 is not particularly limited. The drain wire 31 may be a solid wire or may be a stranded wire.

The material of the drain wire 31 is not particularly limited. As the material of the drain wire 31, one or more conductive materials selected from copper, annealed copper, silver, nickel-plated annealed copper, tin-plated annealed copper, and the like can be used. For example, in order to adjust the elongation or the like of the drain wire 31, the drain wire 31 may be subjected to an annealing process.

### Examples

Although specific examples will be described below, the present invention is not limited to these examples.

### (1) Evaluation Method

Scd21 was measured on two-core cables manufactured in Experimental Examples below.

Scd21 represents the amount of differential-mode to common-mode conversion from Port 1 to Port 2, and is one of mixed-mode S-parameters.

The length of each two-core cable on which Scd21 was measured was 3 meters, and Scd21 was measured by a network analyzer. Three samples of each two-core cable manufactured under the same conditions in the Experimental Examples were evaluated. For example, the evaluation results of a two-core cable manufactured in Experimental Example 4 are depicted in a graph illustrated in FIG. 5. The evaluation results of two-core cables manufactured in the other experimental examples are also depicted in similar graphs. For Scd21, the smaller the maximum value, the more the amount of mode conversion is reduced. Therefore, the intensities of the first peaks 50 from the low-frequency side, where the values became the largest, were obtained, and the average value was calculated as Scd21 of the three samples.

### (2) Manufacturing Conditions for Two-Core Cables

The conditions and results of the Experimental Examples will be described below. Experimental examples 1 through 3 are Examples according to the present disclosure, and Experimental Examples 4 through 6 are Comparative Examples.

### Experimental Example 1

A two-core cable 30 having a cross-sectional structure as illustrated in FIG. 3 was manufactured.

### (1) Coated Wire

Each of two coated wires 11 was configured to include a conductor 111 and an insulating layer 112 that covers the outer surface of the conductor 111, which will be described below.

### (Conductor)

As the conductor 111 of each of the coated wires 11, a copper wire that was subjected to an annealing process was used. The copper wire was a solid wire having an outer diameter of 0.5 mm as indicated in Table 1.

The outer diameter of the conductor 111 was evaluated by the following procedure. In any cross section perpendicular to the longitudinal direction of the conductor 111, the outer diameter of the conductor 111 was measured by a micrometer along the two orthogonal diameters of the conductor 111. The average of values measured at two locations was set as the outer diameter of the conductor 111.

### (Insulating Layer)

As an insulating layer 112 of each of the coated wires 11, an insulating layer including a first insulating layer 1121, a second insulating layer 1122, and a third insulating layer 1123 as illustrated in FIG. 4 was used.

The thicknesses of the three layers were as indicated in Table 1. In Table 1, a first layer corresponds to the first insulating layer 1121, a second layer corresponds to the second insulating layer 1122, and a third layer corresponds to the third insulating layer 1123. The thickness of each of the insulating layers was calculated by measuring the outer diameter of each of the insulating layers in the same manner as the conductor 111 above, and dividing, by 2, a value obtained by subtracting the outer diameter of a layer located inward relative to an insulating layer to be evaluated from the outer diameter of the insulating layer to be evaluated. For example, in the case of the first insulating layer 1121, the thickness of the first insulating layer 1121 was calculated by dividing, by 2, a value obtained by subtracting the outer diameter of the conductor 111 from the outer diameter of the first insulating layer 1121.

Polyethylene was used as a resin contained in the insulating layer 112. The second insulating layer 1122 was a foam layer, and the foaming ratio was set to 50%. Each of the first insulating layer 1121 and the third insulating layer 1123 was a solid layer having a foaming ratio of 0%.

The foaming ratio of the foam layer was calculated from the ratio of the specific gravity of the foam layer before foaming to the specific gravity of the foam layer after foaming. Specifically, the foaming ratio was calculated by dividing the measured value of the specific gravity after foaming by the measured value of the specific gravity before foaming. The specific gravity of the foam layer before foaming was measured by cutting out a portion that does not contain foam from the foam layer. The specific gravity was measured according to JIS Z 8807 (2012).

### (2) Metal Tape

As illustrated in FIG. 2, a metal tape 12 had a structure in which a resin layer 121 and a metal layer 122 are stacked. The thickness of the entire metal tape 12 was 0.021 mm, the thickness T121 of the resin layer 121 was 12 μm, and the thickness of the metal layer 122 was 9 μm. The resin layer 121 was made of polyethylene terephthalate, and the metal layer 122 was a copper foil. The dissipation factor of the resin layer 121 was higher than the dissipation factor of the insulating layer 112.

As illustrated in FIG. 3, the metal tape 12 was longitudinally wrapped around the two coated wires 11 so as to collectively cover the outer surfaces of the two coated wires 11, and the width of the metal tape 12 was set to 9 mm so that portions of the metal tape 12 overlap each other in a cross section perpendicular to the longitudinal direction of the two-core cable 30. As illustrated in FIG. 2, the first surface 21 of the resin layer 121 of the metal tape 12 was disposed to be located towards the coated wires 11, and the second surface 22 of the metal layer 122 was disposed to be located towards the outer surface of the two-core cable 30.

In a cross section perpendicular to the longitudinal direction of the two-core cable 30, the end portion 12A and the end portion 12B of the metal tape 12 were disposed outward, in the width direction of the two-core cable, relative to the contact point P1 and the contact point P2, respectively. Each of the contact point P1 and the contact point P2 was located between the outer periphery of a corresponding one of the two coated wires 11 and the common external tangent L1 to the two coated wires 11 (see FIG. 1). More specifically, the end portion 12A of the metal tape 12 was disposed in the region R1 between the point P3, which is the intersection of the line L2 passing through the centers O1 and O2 of the two coated wires 11 and the metal tape 12, and the above-described contact point P1. The end portion 12B of the metal tape 12 was disposed in the region R2 between the point P4, which is the intersection of the line L2 passing through the centers O1 and O2 of the two coated wires 11 and the metal tape 12, and the above-described contact point P2. In the following other Experimental Examples, the end portion 12A and the end portion 12B of the metal tape 12 were disposed in the above-described region R1 and the above-described region R2, respectively.

### (3) Drain Wire

As indicated in Table 1, as a drain wire 31, a tin-plated copper wire that was subjected to an annealing process was used. The tin-plated copper wire was a solid wire having an outer diameter of 0.2 mm.

As illustrated in FIG. 3, the drain wire 31 was disposed on the side surface of the two-core cable 30. Specifically, the drain wire 31 was disposed outward, in the width direction of the two-core cable 30, that is, in the X-axis direction, relative to the line A passing through the center O1 of a corresponding one of the coated wires 11 and extending along the thickness direction of the two-core cable 30 as illustrated in FIG. 3.

### (4) Wrapping Tape

As a wrapping tape 13, a resin tape made of polyethylene terephthalate was used. The thickness and the width of the wrapping tape 13 were as indicated in Table 1. The wrapping tape 13 was formed by wrapping the resin tape spirally around the two-core cable 30 along the longitudinal direction of the two-core cable 30 with the twist pitch indicated in Table 1.

Note that the resin tape was spirally wrapped around the two-core cable 30 along the longitudinal direction of the resin tape while a force was applied such that the tension became 1.96 N (200 gf).

The above-described Scd21 was evaluated on the obtained two-core cable. Table 2 indicates the evaluation results.

### Experimental Example 2

A two-core cable was manufactured in the same manner as Experimental Example 1, except that a wrapping tape 13 was formed by wrapping a resin tape around the two-core cable along the longitudinal direction of the resin tape while applying a force such that the tension became 3.43 N (350 gf).

The above-described Scd21 was evaluated on the obtained two-core cable. Table 2 indicates the evaluation results.

### Experimental Example 3

A two-core cable was manufactured in the same manner as Experimental Example 1, except that a wrapping tape 13 was formed by wrapping a resin tape around the two-core cable along the longitudinal direction of the resin tape while applying a force such that the tension became 3.92 N (400 gf).

The above-described Scd21 was evaluated on the obtained two-core cable. Table 2 indicates the evaluation results.

### Experimental Example 4

A two-core cable was manufactured in the same manner as Experimental Example 1, except that a metal layer 122 of a metal tape 12 was disposed to be located towards the two coated wires 11. A wrapping tape 13 was formed by wrapping a resin tape around the two-core cable along the longitudinal direction of the resin tape while applying a force such that the tension became 1.96 N (200 gf).

### Experimental Example 5

A two-core cable was manufactured in the same manner as Experimental Example 4, except that a wrapping tape 13 was formed by wrapping a resin tape around the two-core cable along the longitudinal direction of the resin tape while applying a force such that the tension became 3.43 N (350 gf).

The above-described Scd21 was evaluated on the obtained two-core cable. Table 2 indicates the evaluation results.

### Experimental Example 6

A two-core cable was manufactured in the same manner as Experimental Example 4, except that a wrapping tape 13 was formed by wrapping a resin tape around the two-core cable along the longitudinal direction of the resin tape while applying a force such that the tension became 3.92 N (400 gf).

The above-described Scd21 was evaluated on the obtained two-core cable. Table 2 indicates the evaluation results.

TABLE 1

| | | | | |
|---|---|---|---|---|
| CONDUCTOR | | OUTER | mm | 0.5 |
| | | DIAMETER | | |
| INSULATING | FIRST LAYER | THICKNESS | mm | 0.05 |
| LAYER | SECOND | THICKNESS | mm | 0.3 |
| | LAYER | FOAMING | % | 50 |
| | | RATIO | | |
| | THIRD LAYER | THICKNESS | mm | 0.05 |
| METAL TAPE | | THICKNESS | mm | 0.021 |
| | | WIDTH | mm | 9 |
| DRAIN WIRE | | OUTER | mm | 0.2 |
| | | DIAMETER | | |
| WRAPPING TAPE | | THICKNESS | mm | 0.01 |
| | | WIDTH | mm | 4 |
| | | PITCH | mm | 2.3 |

TABLE 2

| | Scd21 [db] |
|---|---|
| EXPERIMENTAL EXAMPLE 1 | −28.1 |
| EXPERIMENTAL EXAMPLE 2 | −24.9 |
| EXPERIMENTAL EXAMPLE 3 | −28.2 |
| EXPERIMENTAL EXAMPLE 4 | −15.2 |
| EXPERIMENTAL EXAMPLE 5 | −15.8 |
| EXPERIMENTAL EXAMPLE 6 | −22.2 |

As described above, Scd21 was measured on three samples manufactured under the same conditions in each of the Experimental Examples, and the intensities of the first peaks 50 (see FIG. 5) from the low frequency side, where the values became the largest, were obtained, and the average value was calculated. Table 2 indicates the average values calculated in the Experimental Examples.

According to the results indicated in Table 2, it was confirmed that two-core cables of Experimental Examples 1 through 3, in which the resin layers 121 of the metal tapes 12 were located towards the two coated wires 11, that is, located inward relative to the metal tapes 12, can reduce Scd21 as compared to two-core cables of Experimental Examples 4 through 6.

Accordingly, it was confirmed that, in a two-core cable that includes a metal tape having a structure in which a resin layer and a metal layer are stacked, the amount of differential-mode to common-mode conversion can be reduced by disposing the resin layer to be located towards the two coated wires.

Although the embodiments have been described in detail above, the present invention is not limited to a specific embodiment, and various modifications and alterations can be made within the scope described in the claims.

What is claimed is:

1. A two-core cable comprising:
two coated wires each including a conductor and an insulating layer, the insulating layer covering an outer surface of the conductor; and
a metal tape configured to collectively cover outer surfaces of the two coated wires,
wherein the metal tape has a structure in which a resin layer and a metal layer are stacked, and the resin layer is located towards the two coated wires relative to the metal layer.

2. The two-core cable according to claim 1, wherein portions of the metal tape overlap each other in a cross section perpendicular to a longitudinal direction of the two-core cable, and
in the cross section, both end portions of the metal tape are respectively disposed outward, in a width direction of the two-core cable, relative to contact points each of which is an intersection point of an outer periphery of a corresponding coated wire of the two coated wires and a common external tangent to the two coated wires.

3. The two-core cable according to claim 2, wherein, in the cross section, the both end portions of the metal tape are respectively disposed in regions each of which is located between the contact point and an intersection of a line passing through centers of the two coated wires and the metal tape.

4. The two-core cable according to claim 1, wherein the metal tape is longitudinally wrapped around the two coated wires.

5. The two-core cable according to claim 1, wherein the resin layer has a thickness of 5 μm or more to 25 μm or less.

6. The two-core cable according to claim 1, wherein a dissipation factor of the resin layer is higher than a dissipation factor of the insulating layer.

7. The two-core cable according to claim 1, wherein the insulating layer includes a foam layer that is a foamed layer.

8. The two-core cable according to claim 7, wherein the foam layer has a foaming ratio of 0% or more to 70% or less.
